(19) United States
(12) Patent Application Publication
(10) Pub. No.: US 2003/0145061 A1
(43) Pub. Date: Jul. 31, 2003

(54) Server management system

(76) Inventor: Yusuke Kochiya, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/342,274

(22) Filed: Jan. 15, 2003

(30) Foreign Application Priority Data
Jan. 17, 2002 (JP) 2002-008787

(51) Int. Cl. G06F 15/16

(52) U.S. Cl. 709/208; 709/222; 709/221

(57) ABSTRACT

A server management system, in which the setting work for a plurality of managed servers each having a network boot-up device is collectively carried out by acquiring the required information from a central management server or a storage server at the time of activation. The central management server or the storage server has collectively stored therein all of the programs, the setting information and the data used by the individual managed servers to be managed, thereby making it possible to reduce the capacity of the storage unit. Further, the work of updating the program and the back-up can be performed collectively, and therefore the storage unit of each managed server is eliminated. As a result, a multiplicity of servers of various types can be collectively introduced, operated and managed thereby to reduce the work load for server management.

### BACKGROUND OF THE INVENTION

The present invention relates to a server management system, or in particular to a server management system suitably used for introducing, operating and managing at least one server computer such as a mail server, a web server or an application server.

With the extension of the internet technique, demand has increased more and more for a server computer which provides various services including electronic mail and web through the internet. Also, an internet data center or the like has come to be required to introduce, operate and manage a multiplicity of servers of various types collectively.

For introducing these servers, it is necessary to install an operating system (OS) and a program and further to set a network and various programs in each server unit. In the case where a multiplicity of server computers to be introduced are involved, however, this work consumes a great amount of time.

In operation, on the other hand, the program is required to be updated or backed up for each server unit. This not only consumes a very large amount of time but also complicates the management. Further, in the case where the increased data decreases the available capacity of the storage unit of each server, the capacity of the storage unit is required to be added for each server.

As described above, the conventional server management requires the work of installing and setting a program, updating and backing up the program and adding the storage unit for each storage unit at the time of introducing, operating or managing a multiplicity of servers of various types. The problem is that these jobs consumes a very large amount of time.

### SUMMARY OF THE INVENTION

The object of the present invention is to solve the problem points of the prior art described above and provide a server management system for reducing the amount of jobs for server management by making possible collective introduction, operation and management of a multiplicity of servers of various types.

According to one aspect of the invention, there is provided a server management system comprising at least one managed server to be managed and a central management server connected to each other through a network, the managed server being operated and managed by the central management server, wherein the central management server possesses network information, a bootloader, a program, setting information and data required for activating the managed server, and each managed server being activated acquires the required information from the central management server.

According to another aspect of the invention, there is provided a server management system comprising a storage server for storing the program, the setting information and the data required for operation of at least an managed server, wherein the central management server possesses the network information and a bootloader required for activating at least the managed server, and at least the managed server includes a network boot means and acquires the required information from the central management server and the storage server at the time of activation.

In this invention, the provision of the means described above makes it possible to collectively carry out the work for introducing at least the managed server, from the central management server. Also, according to this invention, the managed servers share a program file executed thereby, and therefore the capacity of the storage unit can be reduced. In the case where the program is updated or otherwise changed, for example, all the managed servers using the particular program can be updated by updating the shared program file.

The above and other objects, features and advantages will be made apparent by the detailed description of embodiments taken in conjunction with the accompanying drawings.

### BRIEF DESCRIPTION OF THE DRAWINGS

FIG. 1 is a block diagram showing a configuration of a server management system according to the invention.

FIG. 2 is a block diagram showing another configuration of a server management system according to the invention.

FIG. 3 is a block diagram showing still another configuration of a server management system according to the invention.

### DESCRIPTION OF THE EMBODIMENTS

A server management system according to an embodiment of the invention will be explained in detail below with reference to the drawings.

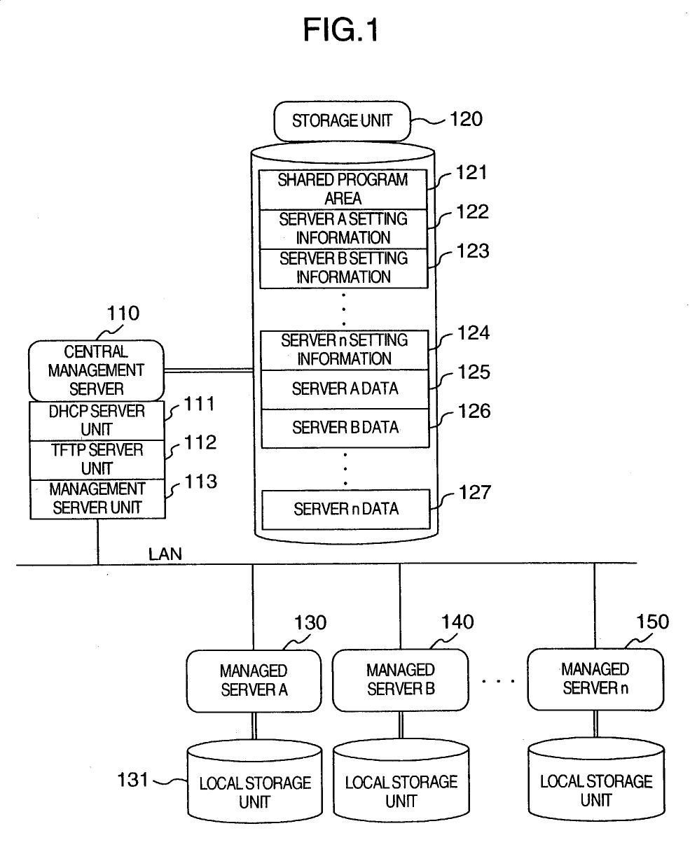

FIG. 1 is a block diagram showing a configuration of a server management system according to a first embodiment of the invention. In FIG. 1, reference numeral 110 designates a central management server, numeral 111 a DHCP server unit, numeral 112 a TFTP server unit, numeral 113 a management server file, numeral 120 a storage unit, numeral 121 a shared program area, numeral 122 a server A setting information area, numeral 123 a server B setting information area, numeral 124 a server n setting information area, numeral 125 a server A data area, numeral 126 a server B data area, numeral 127 a server n data area, numerals 130, 140, 150 managed servers A to n, respectively, and numeral 131 a local storage unit. The character n is an arbitrary positive integer.

The server management system shown in FIG. 1 comprises the central management server 110, the storage unit 120 connected to the central management server 110 and the managed servers 130, 140, 150 managed by the central management server 110. The central management server 110 and the managed servers 130, 140, 150 are connected to each other through a network such as LAN. The central management server 110 includes the DHCP (Dynamic Host Configuration Protocol) server unit 111, the TFTP (Trivial File Transfer Protocol) server unit 112 and the management server unit 113. The storage unit 120 includes the shared program area 121, the server A setting information area 122, the server B setting information area 123, the server n setting information area 124, the server A data area 125, the server B data area 126 and the server n data area 127. Further, the managed servers 130, 140, 150 are each connected with the local storage unit 131.

In a server management system configured as described above, assume that the managed server A 130 is introduced anew. In this case, the managed server A 130, once activated, requests the IP address, the file name of the boot loader and the loader parameter from the DHCP server unit 111 on the central management server 110. In response to this request, the DHCP server unit 111 transmits the IP address, the file name of the boot loader and the loader parameter to the managed server A 130. Based on the information thus received, the managed server A 130 requests a boot loader from the TFTP server unit 112 on the central management server 110. In response to this request, the TFTP server unit 112 transmits a boot loader to the managed server A 130. Next, the managed server A 130 requests a boot image from the TFTP server unit 112. In response to this request, the TFTP server unit 112 transmits a boot image to the managed server A 130. The managed server A 130 is activated using this boot image.

In the way described above, the shown server management system can carry out the setting work for new introduction of the managed server A 130 from the central management server 110. Even in the case where a plurality of servers are introduced, the setting work for all the managed servers can be carried out from the central management server 110.

After that, the managed server A 130 acquires a copy of the required program from the shared program area 121 in the storage unit 120 of the central management server 110, and stores it in the local storage unit 131 of the managed server A 130. Also, the managed server A 130 executes the program by acquiring the data and the setting information for operating the program from the server A setting information area 121 and the server A data area 125 in the storage unit 120 of the central management server 110. In the case where the setting information or the data are changed, the managed server A 130 updates the server A setting information area 121 or the server A data area 125, respectively. The managed server B 140 uses the server B setting information area 123 and the server B data area 126. Similarly, the managed server n 150 uses the server n setting information area 124 and the server n data area 127.

As described above, even in the case where a plurality of managed servers to be managed are involved, the shown server management system can acquire backup data collectively in view of the fact that all the programs, the setting information and the data are stored in the storage unit 120 of the central management server 110. Further, even in the case where the number of the managed servers is increased, the capacity of the shared program area 121 can be saved since the shared program area 121 has only one program to be shared.

In the case where the program stored in the shared program area 121 is changed, the system manager updates only the shared program area 121. After that, the management server unit 113 operating in the central management server 110 notifies all the managed servers utilizing the updated program that the program has been updated. Each managed server that has received the notification acquires the new program stored in the shared program area 121, and executes the particular program by copying it in the local storage area. In the case where a program is changed, therefore, all the managed servers can update the program by changing only the shared program area 121.

The processing according to the first embodiment of the invention described above is executed under the control of the manager from an input unit and an output unit not shown which belong to the central management server.

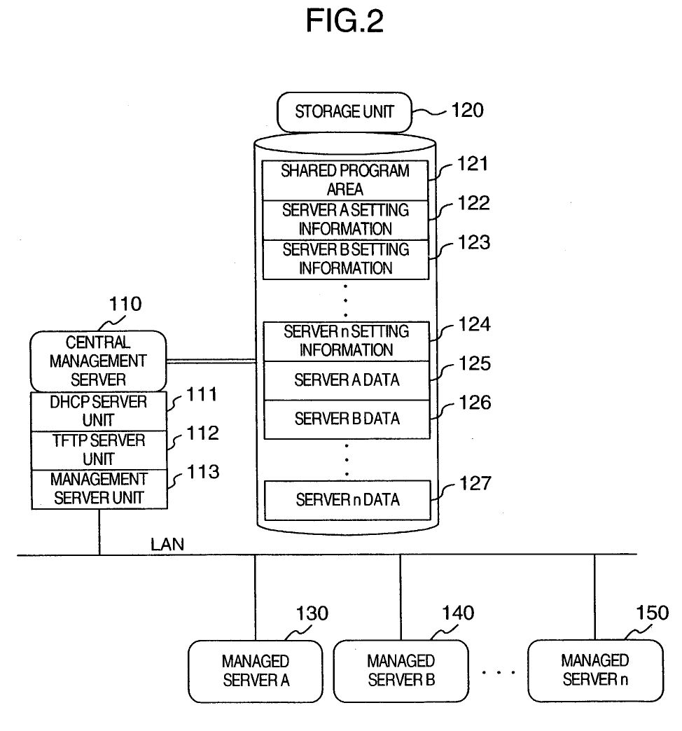

FIG. 2 is a block diagram showing a configuration of the server management system according to a second embodiment of the invention. In FIG. 2, the same reference numerals as those in FIG. 1 designate the same component parts, respectively. The second embodiment of the invention is different from the first embodiment described above only in that the managed servers 130, 14, 150 have no local storage unit.

Next, the operation according to the second embodiment of the invention will be explained on the assumption that the managed server A 130 to be managed, for example, is introduced as in FIG. 1.

The managed server A 130, once activated, requests the IP address, the file name of the bootloader and the loader parameter from the DHCP server unit 111 on the central management server 110. In response to this request, the DHCP server unit 111 transmits the IP address, the file name of the bootloader and the loader parameter to the managed server A 130. Based on the information thus received, the managed server A 130 requests a bootloader from the TFTP server unit 112 on the central management server 110. In response to this request, the TFTP server unit 112 transmits a bootloader to the managed server A 130. Next, the managed server A 130 requests a boot image and a driver program for accessing the storage unit 120 of the central management server 110 from the TFTP server unit 112. In response to this request, the TFTP server unit 112 transmits a boot image and a driver program to the managed server A 130. The managed server A 130 is activated using this boot image.

In the way described above, according to the second embodiment of the invention, the setting work for new introduction of the managed server A 130 can be carried out from the central management server 110. Even in the case where there are a plurality of servers to be introduced, the setting work for all the managed servers can be carried out from the central management server 110.

After that, the managed server A 130, using the driver program described above, acquires the required program from the shared program area 221 stored in the storage unit 120 of the central management server 110. Further, the managed server A 130 acquires the setting information and the data for operating the program from the server A setting information area 122 and the server A data area 125 in the storage unit 120 of the central management server 110 and thereby executes the program. In the case where the setting information or the data is changed, the managed server A 130 updates the server A setting information area 122 or the server A data area 125, respectively.

The managed server B 140 uses the server B setting information area 123 and the server B data area 126. Similarly, the managed server n 150 uses the server n setting information area 124 and the server n data area 127. Even in the case where a plurality of managed servers to be managed are involved, therefore, the fact that all the programs, the setting information and the data are stored in the storage unit 120 of the central management server 110 permits the server management server to can acquire backup data collectively. Further, even in the case where the number of the managed servers is increased, the capacity of the shared program area 121 can be saved since the shared program area 121 has only one program to be shared.

In the case where the program stored in the shared program area 121 is changed, the system manager updates only the shared program area 121. After that, the management server unit 113 operating in the central management server 110 notifies all the managed servers utilizing the updated program that the program has been updated. Each managed server that has received the notification acquires the new program stored in the shared program area 121, and executes the particular program. In the case where a program is changed, therefore, all the managed servers can update the program by changing only the shared program area 121.

According to the second embodiment of the invention described above, each managed server includes only a central processing unit and a main storage unit without any local storage unit. Therefore, the number of the parts of the managed server can be reduced for an improved reliability of each managed server.

The processing according to the second embodiment of the invention described above is performed under the control of the manager from an input unit and an output unit not shown owned by the central management server.

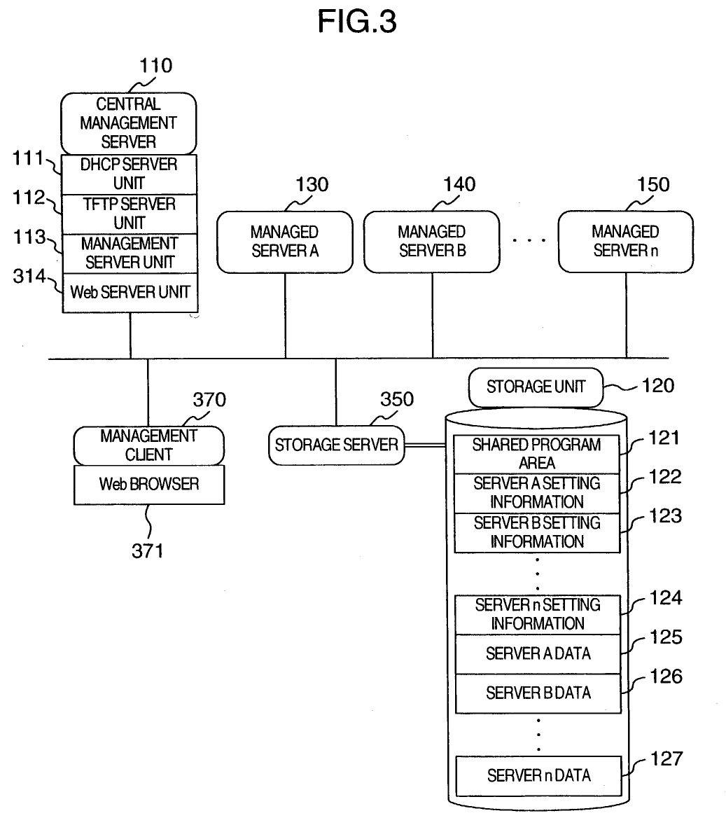

FIG. 3 is a block diagram showing the configuration of a server management system according to a third embodiment of the invention. In FIG. 3, numeral 314 designates a web server unit, numeral 350 a storage server, numeral 370 a management client and numeral 371 a web browser, the other reference numerals designating the component parts designated by the same reference numerals, respectively, in FIG. 1.

The third embodiment of the invention shown in FIG. 3 is different from the second embodiment explained with reference to FIG. 2 in that the central management server 110 further includes a web server unit, that the web browser 371, the management client 370 having the input/output unit not shown and the storage server 350 are connected on the network of LAN or the like, and that the storage unit 120 is associated with the storage server 350. The configuration of the other parts remains the same as in FIG. 2. The management client 370 can operate the central management server 110 by being connected to the web server unit 314 on the central management server 110 using the web browser 371.

Next, the operation of the third embodiment of the invention will be explained on the assumption that the managed server A 130, for example, is introduced anew as in the case of FIG. 1.

The managed server A 130, once activated, requests the IP address, the file name of the bootloader and the loader parameter from the DHCP server unit 111 on the central management server 110. In response to this request, the DHCP server unit 111 transmits the IP address, the file name of the bootloader and the loader parameter to the managed server A 130. Based on these information thus received, the managed server A 130 requests a bootloader from the TFTP server unit 112 on the central management server 110. In response to this request, the TFTP server unit 112 transmits a bootloader to the managed server A 130. Next, the managed server A 130 requests a boot image and a driver program for accessing the storage unit 120 of the storage server 350 from the TFTP server unit 112. In response to this request, the TFTP server unit 112 transmits a boot image and a driver program to the managed server A 130. The managed server A 130 is activated using this boot image.

The above-mentioned processing is carried out by the management client 370 under the control of the manager using the web server unit 314 of the central management server 110 and the web browser 371 of the management client 370 having an input unit and an output unit.

As described above, the setting work for new introduction of the managed server A 130 can be performed by the management client 370, and even in the case where there are a plurality of servers to be introduced, the setting work for all the servers can be carried out by the management client 370.

After that, the managed server A 130 acquires the required program from the shared program area 121 stored in the storage unit 120 of the storage server 350 using the above-mentioned driver program. Further, the managed server A 130 executes the program by acquiring the setting information and the data for operating the program, from the server A setting information area 122 and the server A data area 125 in the storage unit 120 of the storage server 350. In the case where the setting information or the data is changed, the server A setting information area 122 or the server A data area 125, respectively, is updated. The managed server B 140 uses the server B setting information area 123 and the server B data area 126. Similarly, the server n 150 uses the server setting information area 124 and the server n data area 127.

As described above, even in the case where a plurality of managed servers are involved, the fact that the programs, the setting information and the data are all stored in the storage unit 120 of the storage server 350 makes it possible to back up the managed servers collectively. Further, even in the case where the number of the managed servers is increased, the capacity of the shared program area 121 can be reduced in view of the fact that only one shared program exists in the shared program area 121.

In the case where the program stored in the shared program area 121 is changed, the manager updates only the shared program area 121. After that, the management server unit 113 operating in the central management server 110 notifies all the managed servers using the updated program that the program has been updated. Each managed server that has received the notification acquires a new program stored in the shared program area 121 and executes the program. In the case where the program is changed, therefore, all the managed servers can update the current program simply by changing the shared program area.

The server management system according to the third embodiment of the invention described above comprises only a central processing unit and a main storage unit without any local storage unit. As a result, the number of the component parts of each managed server can be reduced for an improved reliability of each managed server. Further, in view of the fact that the data area used by each managed server is stored in the storage server 350 independent of the central management server 110, the available capacity of the storage unit 120, if reduced, can be easily increased by adding a storage server or a storage unit.

Furthermore, the provision of the management client 370 separate from the central management server 110 permits each managed server to be managed from a remote place through an internet or the like.

The server management system according to the third embodiment of this invention may be so configured that each of the managed servers shown in FIG. 3 includes a local storage unit. Also, a management client can be included in the first and second embodiments of the invention shown in FIGS. 1 and 2.

According to the embodiments of the invention described above, the setting work for a plurality of managed servers can be collectively carried out from the central management server, and therefore the operating efficiency can be improved with a shorter working time. Also, in view of the fact that a program is shared by a plurality of managed servers, the capacity of the storage unit can be saved while at the same time improving the efficiency of the updating job. Also, according to the embodiments of the invention, the setting information and the data for the managed servers are recorded collectively in a single storage unit, and therefore the backup work can be collectively carried out, thereby improving the work efficiency and shortening the work time. Furthermore, the need of providing a storage unit for each of a plurality of managed servers can be eliminated. Further, according to the embodiments of the invention, the use of a storage server makes it easy to increase the capacity of the storage unit independently of the management mechanism for the central management server on the one hand and makes it possible to manage the whole system from a remote place by the management function of the web browser on the other hand.

It will thus be understood from the foregoing description that according to this invention, a multiplicity of servers of a multiplicity of types can be collectively introduced, operated and managed thereby to reduce the amount of work for server management.

It is apparent to those skilled in the art that the present invention is not limited to the embodiments described above, but can be altered or modified variously within the scope of the appending claims without departing from the spirit of the invention.

What is claimed is:

1. A server management system comprising at least one managed server to be managed and a central management server connected to each other through a network, said central management server operating and managing said at least one managed server,
wherein said central management server holds the activation information required for activating said at least one managed server, and
wherein each said managed server is activated by acquiring said activation information from said central management server at the time of activation.

2. A server management system according to claim 1,
wherein said activation information includes selected one of the network information, a bootloader for the managed server, an execution program for the managed server, setting information for the managed server and data used by the managed server.

3. A server management system according to claim 1,
wherein said central management server includes a storage unit, and
wherein said storage unit includes a shared program area for storing the program used by all of said at least one managed server, a setting information area for storing the setting information used individually by said at least one managed server, and a data area for storing the data used individually by said at least one managed server.

4. A server management system comprising at least one managed server to be managed and a central management server connected to each other through a network, said central management server operating and managing said at least one managed server,
wherein said network is connected with a storage server for storing, for each of said at least one managed server, the program and the setting information required for operation of said managed server and the data used by said managed server;
wherein said central management server includes the network information and the boot loader required for activating said managed server; and
wherein said managed server includes network boot means and acquires the required activation information from said central management server and said storage server at the time of activation.

5. A server management system according to claim 4,
wherein said storage server includes a shared program area for storing the program used by all of said at least one managed server, a setting information area for storing the setting information used individually by said managed server and a data area for storing the data used individually by said managed server.

6. A server management system comprising at least one managed server to be managed and a central management server connected to each other through a network, said central management server operating and managing said at least one managed server,
wherein said managed server loads the program thereof from selected one of the central management server and the shared program area of the storage server on the network, loads the setting information utilized individually by each managed server from the setting information area, and loads the data individually utilized by each said managed server from the data area.

7. A server management system according to claim 6,
wherein said managed server has the program thereof stored in a main storage unit.

8. A server management system according to claim 6,
wherein said managed server is such that the program in said shared program area, said setting information and the required data in said data area are loaded and stored in the local storage unit associated with said particular managed server.

9. A server management system comprising at least one managed server to be managed and a central management server connected to each other through a network, said central management server operating and managing said at least one managed server,
wherein said central management server includes a shared program area for storing the program used by all of said at least one managed server, a setting information area for storing the setting information used individually by said managed server and a data area for storing the data used individually by said managed server,
wherein the program, the setting information and the data are distributed to said at least one managed server from said shared program area, said setting information area and said data area, and
wherein in the case where said program, said setting information and said data are updated, said shared program area, said setting information area and said data area are changed, respectively.

10. A server management system according to claim 9,
wherein the information in said shared program area, said setting information area and said data area of said central management server are collectively backed up.
